(19) United States
(12) Patent Application Publication
(10) Pub. No.: US 2026/0277902 A1
(43) Pub. Date: Sep. 17, 2026

(54) Statistics For In-Memory Graph-Based Vector Index In A RDBMS Using A Cost-Based Optimizer

(71) Applicant: Oracle International Corporation, Redwood Shores, CA (US)

(72) Inventors: Ioannis Alagiannis, Zurich (CH); Marco Arnaboldi, Zurich (CH); Martin Brugnara, Zurich (CH); Laurent Phillipe Daynes, Saint-Ismier (FR); Vlad Ioan Haprian, Zurich (CH)

(21) Appl. No.: 19/281,237

(22) Filed: Jul. 25, 2025

Related U.S. Application Data
(60) Provisional application No. 63/771,521, filed on Mar. 13, 2025.

(51) Int. Cl. G06F 16/2453

(52) U.S. Cl. CPC G06F 16/24545

(57) ABSTRACT

A system for collecting statistics for an in-memory graph-based vector index executes a plurality of sample queries based on a set of search parameter values, a set of sampling filter ratios, and a set of sample vectors to perform a similarity search of a vector store using the in-memory graph-based vector index. The system determines, for each sample query, at least one cost statistic based on the execution and stores the cost statistics for a plurality of sample queries. A database system executes a vector query with a filter condition to search the vector store. The database system executes the vector query by determining a cost estimation for graph-based index access based at least in part on the set of cost statistics and executing the vector query based at least in part on the cost estimation for graph-based index access.

### RELATED APPLICATION DATA AND CLAIM OF PRIORITY

This application claims the benefit of U.S. Provisional Application No. 63/771,521 (Attorney Docket No. 50277-6529), filed Mar. 13, 2025, the contents of which are incorporated by reference for all purposes as if fully set forth herein.

### FIELD OF THE INVENTION

The present invention relates to cost-based optimizers in relational database management systems and, more specifically, to statistics for in-memory graph-based vector indexes.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

A vector is a set of numbers that represents the features of an object, whether that object is a word, a sentence, a document, an image, or a video or audio file. Vectors are needed because comparing or searching this type of unstructured content is difficult for computers. Comparing or searching vectors, on the other hand, is much easier and is based on well-understood mathematical operations. Vectors are stored in a database with (or with a link to) the data objects on which they are based. Vectors that are mathematically close to one another tend to describe objects with similar features, so you can quickly compare or search them and return objects that are alike. One might also form a query vector that includes only certain features. A search will return objects with features similar to those specified in the query vector.

In data science, similarity search frequently appears in the Natural Language Processing (NLP) domain, search engines, or recommender systems, where the most relevant documents or items are retrieved in response to a query. For example, a top-k similarity search is a vector similarity search that refers to the process of finding the k closest items in a dataset that are similar to a given query vector. The concept of similarity is expressed via some distance function between vectors in the vector space (e.g., Euclidean distance, cosine distance, etc.). Top-k approximate similarity search is an approximate similarity search that aims to reduce the cost of similarity queries by relaxing the correctness constraint (recall), i.e., the k vectors in the approximate result are approximately the closest, but may not necessarily be the closest, to the query vectors. Recall is the ability of a model to identify all relevant cases within a dataset. Mathematically, “recall” is defined as the number of true positives divided by the number of true positives plus the number of false negatives. In the top-k similarity search context, recall is based on the number of correct results returned. A recall equal to 1 means that all the found results are true positives, while a recall equal to 0 means that all the found results are false positives.

There exists a large variety of different ways to improve search performance in massive volumes of data. Demand is growing for similarity search on data that resides in relational databases. Until recently, the solutions proposed to users involved constructing vector indexes outside of the databases holding the data of interest. One solution involves constructing vector indexes in dedicated similarity search engines, while another solution involves migrating data to a vector database. These solutions are unsatisfactory because they substantially increase the complexity of data management within the enterprise, resulting in significant loading and data transfer costs to external engines. Furthermore, they are not practical in the presence of data manipulation language (DML) operations (e.g., insertions and deletions), which are common in enterprise environments. To address these challenges, relational databases are being extended with new data types (e.g., VECTOR) and Structured Query Language (SQL) operators, enabling the creation of vectors over existing or new database tables, as well as incorporating similarity search capabilities.

However, without specific support, the performance of similarity search will be notably worse than the performance offered by dedicated vector engines. A graph-based vector index supports vector search by providing an index that organizes vectors into a graph network, where similar vectors are connected to each other. The graph organization of vectors allows for fast retrieval of similar vectors during query vector search. In particular, a main-memory graph-based vector index that enables fast navigation through the vectors is essential for optimal performance. Additionally, to fully leverage the performance of a graph-based vector index in a RDBMS, it is crucial to integrate the index into the cost-based access path selection process of the RDBMS. A cost-based optimizer utilizes costing methods to estimate resource usage for a given plan and determine the most efficient way to execute a query. The lower the cost, the more efficient an execution plan is expected to be. The vector index access path should be accurately estimated and compared with existing access paths to determine the most cost-effective execution plan.

Graph-based vector indexes such as the Hierarchical Navigable Small World (HNSW) index, the Vamana index, and the CUDA ANN Graph-based (CAGRA) index have been proven to be among the best industrial and academic solutions for high-performance approximate similarity search in terms of recall and Query Per Second (QPS) metrics, allowing for efficient navigation through complex high-dimensional datasets. One of the main challenges in making a graph-based vector index usable in real-life industrial scenarios is to properly incorporate it within the decision mechanism (e.g., a cost-based optimizer) that selects execution plans. Optimizer statistics are a collection of data that describe the database and its objects. The optimizer utilizes these statistics to choose the most effective execution plan for each SQL statement. In the context of graph-based vector indexes in systems that make cost-based decisions using an optimizer, statistics that accurately reflect the cost of index access and can be utilized by the optimizer to select the most efficient execution plan are crucial for query performance, scalability, and resource efficiency.

Conventional statistics (e.g., number of rows in a table, number of distinct values in a column, the minimum and the maximum value in a column) and sampling mechanisms cannot be applied to columns containing vectors (e.g., the minimum and the maximum value implies some ordering) or they cannot provide helpful information (e.g., the number of distinct values cannot be used to search for similar vectors or to filter out vectors). At the same time, graph-based vector indexes used for approximate nearest neighbor search have unique characteristics when it comes to filtered search (i.e., vector search combined with attribute filtering); in practice, performance might significantly drop for filtered vector searches especially with low filter ratio ((number of vectors selected according to the filter)/(total number of vectors in the index)).

The problem of generating statistics for graph-based vector indexes used in approximate search queries has not been addressed yet by any relational database system. Existing solutions are either based on heuristics or hard-coded formulas that cannot accurately express the cost of graph-based indexes, potentially resulting in significant overestimation or underestimation of the access cost.

### BRIEF DESCRIPTION OF THE DRAWINGS

In the drawings:

FIG. 1 illustrates Navigable Small World graph traversal for vector search in accordance with an embodiment.

FIG. 2A illustrates a Hierarchical Navigable Small World graph architecture for vector search in accordance with an embodiment.

FIG. 2B illustrates Hierarchical Navigable Small World graph traversal for vector search in accordance with an embodiment.

FIG. 3A illustrates an approximate nearest neighbor search in a graph-based index without a filter in accordance with an embodiment.

FIG. 3B illustrates an approximate nearest neighbor search in a graph-based index with a filter in accordance with an embodiment.

FIG. 4 illustrates the cost tradeoffs between performing an exact search with a filter versus performing an approximate search with a filter in accordance with an embodiment.

FIG. 5 illustrates the use of a filter bitmap to emulate the approximate filter search behavior in accordance with an embodiment.

FIG. 6 is a block diagram illustrating the storage of collected statistics in accordance with an embodiment.

FIG. 7 is a block diagram illustrating graph-based vector index access cost estimation in accordance with an embodiment.

FIG. 8 is a flowchart illustrating the collection of statistics for a graph-based vector index in accordance with an embodiment.

FIG. 9 is a flowchart illustrating the use of collected statistics for cost estimation for a graph-based vector index in accordance with an embodiment.

FIG. 10 is a block diagram that illustrates a computer system upon which aspects of the illustrative embodiments may be implemented.

FIG. 11 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Similarity search over very large sets of data stored in relational tables requires efficient indexing technology such as Hierarchical Navigable Small World (HNSW), a main-memory graph-based vector index with state-of-the-art performance in terms of search latency and recall. In a relational database management system (RDBMS) using a cost-based optimizer, the optimizer relies on statistics (e.g., number of rows to retrieve from a table) to estimate the cost of an access (e.g., retrieval from a table, partition, index), to compute the cost for possible execution plans, and then to select the plan with the lowest cost. The illustrative embodiments provide a solution to exploit the performance of a graph-based index in an RDBMS by collecting statistics that describe the index and allow the optimizer to estimate the cost of the index access path accurately.

At a high level, vector engines with capabilities to construct graph indexes in parallel can be organized into three categories:
RDBMSs with vector analytics features: This category contains all the databases built on top of the well-known entity-relationship (ER) model. This type of RDBMS is the most widespread (e.g., SAP HANA, pgvector) and allows both in-memory features (to speed up queries, especially joins) and some graph support.
Vector processing libraries: This category encompasses all vector engines that operate outside of data stores (e.g., FAISS). This means that vector data should be exported and transferred from the RDBMS to the system in which the engine is running. In this case, the HNSW index is built in-memory, but the external one is not. Depending on the engine, different loaders are used to construct the HNSW, depending on the format in which the data was exported.
Vector database systems: This category comprises systems specifically optimized to map, store, and explore vector datasets (e.g., Pinecone, Milvus). Data is directly created and stored in and managed from the vector database.
   Given the three categories above, the solution of the illustrative embodiments falls in the first category, specifically improving its query performance, scalability, and resource efficiency. Parts of it can be leveraged from vector processing libraries and specialized vector database systems that use cost-based decisions for approximate search using graph-based indexes.

The solution illustrated in the embodiments identifies the primary cost factors for in-memory graph-based vector indexes and introduces a framework for collecting, updating, and storing statistics that allow the optimizer to make informed choices when a graph-based index is available. The solution also provides a cost-based optimizer that utilizes the collected statistics to select an optimal query execution plan. The statistics framework of the illustrative embodiments can enhance query performance and scalability, allowing for improved resource efficiency.

### Graph-Based Approximate Nearest Neighbor Search

### Navigable Small World (NSW)

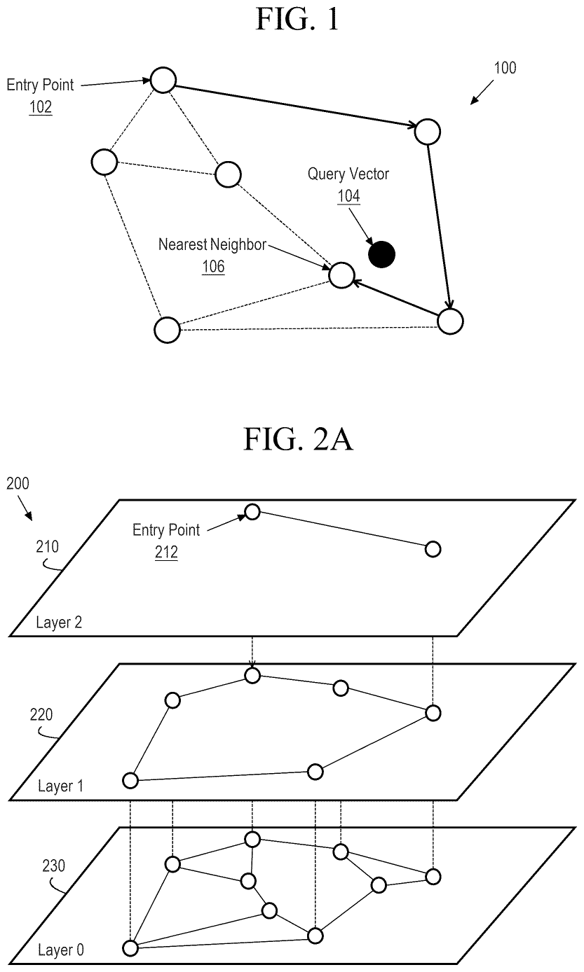

The Navigable Small World (NSW) algorithm is a graph-based approximate nearest neighbor search technique. The vectors form a proximity graph in which each vector is connected to several others based on characteristics such as the distance between vectors and the maximum number of connections allowed per vector. FIG. 1 illustrates Navigable Small World graph traversal for vector search in accordance with an embodiment. Approximate nearest neighbor search using NSW begins with a predefined entry point 102 in the graph 100, accessing a cluster of closely related vectors. The search algorithm tracks a) the vectors encountered while traversing the graph, and b) the vectors closest to the input query vector, query vector 104, found so far. As the search progresses, the algorithm navigates through the graph, exploring and evaluating vectors that might be closer to the query vector. The process concludes when a local minimum has been reached, the current solution, nearest neighbor 106, cannot be further improved, and the closest vectors to the query vector have been identified.

### Hierarchical Navigable Small World (HNSW)

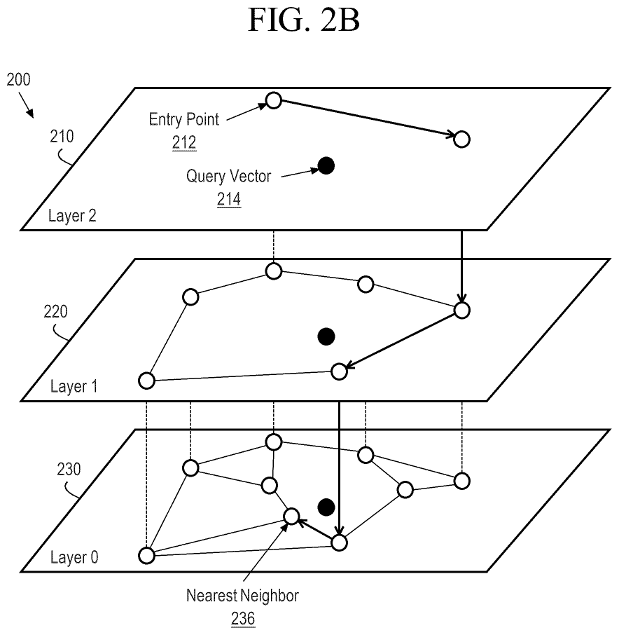

The NSW algorithm demonstrates robust performance up to a certain scale of vector insertions in the graph. Beyond this threshold, the Hierarchical Navigable Small World (HNSW) approach enhances the NSW model by introducing a multi-layered hierarchy. FIG. 2A illustrates a Hierarchical Navigable Small World graph architecture for vector search in accordance with an embodiment. This hierarchical architecture 200 is implemented by distributing connections of the graph across several layers 210, 220, 230, organizing them in a manner where each subsequent layer contains a subset of the links from the layer below. In the example depicted in FIG. 2, layer 2 210 is the “top” layer, layer 1 220 is the “middle” layer, and layer 0 230 is the “bottom” layer. Layer 0 230 includes all vectors of the graph, layer 1 220 includes a subset of the vectors of layer 0, and layer 2 210 includes a subset of the vectors of layer 1. This stratification ensures that the top layer captures long-distance links, effectively serving as express pathways across the graph, while the lower layers focus on shorter links, facilitating fine-grained, local navigation. As a result, searches begin at entry point 212 in the top layer to quickly approximate the region of the target vector, progressively moving to lower layers for a more precise search, significantly improving search efficiency and accuracy by leveraging shorter links (smaller distances) between vectors as one moves from the top layer to the bottom.

FIG. 2B illustrates Hierarchical Navigable Small World graph traversal for vector search in accordance with an embodiment. Starting from the top layer 210, the search in one layer starts at the entry vector 212 in an approximate nearest neighbor search for the query vector 214. Then, for each node, if there is a neighbor that is closer to the query vector than the current node, it jumps to that neighbor. The algorithm continues to do this until it finds a local minimum for the query vector 214. When a local minimum is found in one layer, the search goes to the next layer by using the same vector in that new layer, and the search continues in that layer. This process repeats itself until the local minimum of the bottom layer 230, which contains all the vectors, is found. At this point, the search is transformed into an approximate similarity search using the NSW algorithm around the latest local minimum found to extract the most similar vectors to the input query vector. While the upper layers can have a maximum of connections for each vector, layer 0 230 can have twice as many.

Layers are implemented using in-memory graphs. Each layer uses a separate in-memory graph. When an HNSW index is created, the maximum number of connections per vector in the upper layers can be fine-tuned using the NEIGHBORS parameter. The maximum number of closest vector candidates considered at each step of the search during insertion can be fine-tuned using the efConstruction parameter, where “ef” stands for “exploration factor.”

In the case of an HNSW approximate search, a target accuracy percentage value can be specified to influence the number of candidates considered to probe the search. This is automatically calculated by the algorithm. A value of 100 will tend to impose a similar result as an exact search, although the system may still use the index and will not perform an exact search. The optimizer may choose to use an index still, as it may be faster to do so given the predicates in the query. Instead of specifying a target accuracy percentage value, an efSearch parameter can be specified to impose a certain maximum number of candidates to be considered while probing the index. The higher that number, the higher the accuracy.

### Filtered Graph-Based Approximate Nearest Neighbor Search

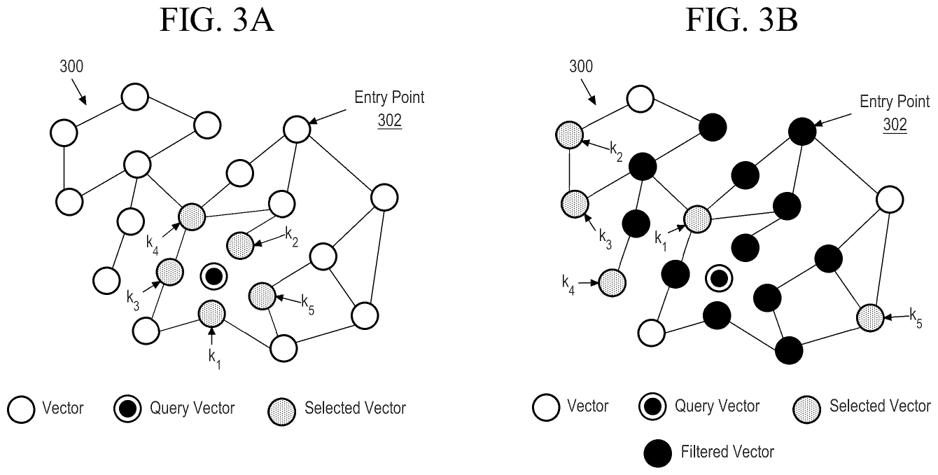

Many real-world applications require answering filtered approximate nearest neighbor search (ANNS) queries (e.g., find the closest vectors of an input query that also match a given filter such as date, age group, value range, complex expression, sub-query etc.). Typical graph-based ANNS algorithms such as HNSW can be extended to consider filter constraints. In case of a multi-layered hierarchy (e.g., HNSW) the filtering is applied at the last layer (densest layer). The major difference from non-filter ANNS is that only vectors for which the filter qualifies can be potentially added as candidates for the final result. Nevertheless, the vectors for which the filter does not qualify can still be visited and used for the graph traversal. FIG. 3A illustrates an approximate nearest neighbor search in a graph-based index without a filter in accordance with an embodiment. As seen in FIG. 3A, the ANNS starts at entry point 302, searches the graph-based index (e.g., layer 0 of an HNSW index), and selects the top-k vectors that are nearest the query vector. In this case, k=5, and the nearest neighbors include vectors k₁, k₂, k₃, k₄, and k₅.

FIG. 3B illustrates an approximate nearest neighbor search in a graph-based index with a filter in accordance with an embodiment. The black nodes depict vectors in the graph for which the under-evaluation filter does not qualify; thus, even though they might be closer to the input query vector, they are not selected for the final result.

There are three high-level strategies that can be used for filtering:
Pre-filter: This strategy initially computes the filter evaluation on the base table and then traverses the graph vector index for the corresponding vectors. This strategy aims at narrowing down the vector search space at an early stage, and it can be very fast if the filter predicates are very selective (most rows are filtered out).
In-filter: This strategy starts by traversing the graph vector index and invokes the filtering only for each vector matching a candidate for the result set. This can be better than pre-filtering when more rows pass the filter predicates. In this case, the number of vector candidates to consider, while traversing the HNSW vector index, might be significantly fewer than the number of rows that pass the filters.
Post-filter: Contrary to pre-filtering and in-filtering strategies, post-filtering performs “pure” vector search, and after obtaining the vector search results, the filter is applied. This approach might work well if the filter is not very restrictive; nevertheless, if the filter predicates are very selective, post-filtering might cause a significant drop in recall (i.e., most rows in the result are filtered out after the filter is applied).
   The strategies above come with different trade-offs, and there is no “one size fits all” strategy. Depending on the dataset, the predicates, the query, the projected values (if any), and other factors, a different strategy may be the most appropriate. Thus, it is essential to accurately estimate the cost of each strategy to determine the most efficient execution plan. The solution of the illustrative embodiments works in this direction. It provides a cost-based optimizer with the required estimations to evaluate the cost of different plans exploiting a graph-based vector index (e.g., HNSW).

### Challenges with Graph-Based Vector Indexes

Graph-based vector indexing technology, such as HNSW, is considered the state-of-the-art in terms of search latency and recall, and thus, it has been widely adopted by industry to provide users with approximate vector search capabilities. Graph-based vector indexes are highly effective in answering non-filter queries; however, graph-based approximate nearest neighbor search with filters presents additional challenges due to the characteristics of graph-based vector indexes. In practice, performance might significantly drop for filtered vector searches, especially with a low filter ratio ((the number of vectors selected according to the filter)/(total number of vectors in the index)).

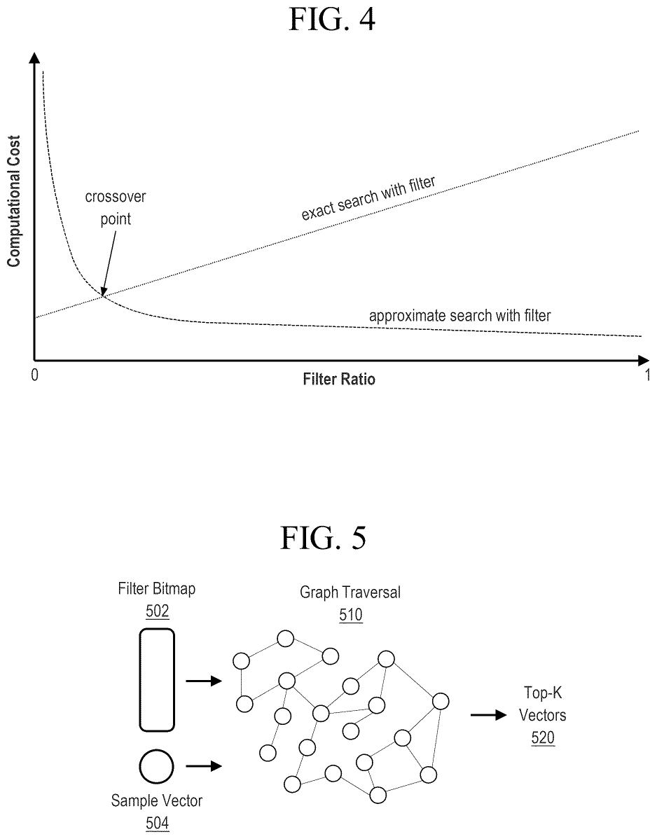

FIG. 4 illustrates the cost tradeoffs between performing an exact search with a filter versus performing an approximate search with a filter in accordance with an embodiment. As the filter ratio decreases, the approximate search using a graph-based vector index becomes more expensive than the exact search. This is due to the way the search algorithm works for graph-based vector indexes; only vectors that qualify under the filter can be potentially added as candidates for the final top results. Thus, a low filter ratio results in spending more time on graph traversal to identify a sufficient number of top candidates for the given input query vector.

The crossover point at which the approximate filtered search starts becoming more expensive is not fixed. It might shift towards the left or the right depending on the graph index parameters (e.g., efConstruction or efSearch for HNSW), the vector dimensionality, the query parameters (e.g., efSearch for HNSW, number of top values to retrieve “k”), and the dataset being used. As a result, pre-selecting a specific threshold (e.g., below 10%, always choosing exact search) is not recommended, as it can lead to suboptimal performance.

As shown in FIG. 4, a cost-based optimizer should use the exact search if the filter ratio is less than the crossover point and use the approximate search if the filter ratio is greater than the crossover point. However, the cost-based optimizer must first estimate the cost of using the approximate search with the filter for various filter ratios. The illustrative embodiments provide a solution for collecting statistics that can be used to estimate the cost of the approximate search using a graph-based vector index. The illustrative embodiments also provide a cost-based optimizer that estimates the cost of the approximate search with the filter using the graph-based vector index based on the collected statistics. The estimated cost can then be compared to the cost of other access paths to select the appropriate query execution plan.

### Statistics For Graph-Based Vector Index

The illustrative embodiments are described in the context of relational database systems that use main memory graph index representations. More specifically, the illustrative embodiments are described with reference to HNSW as a main memory vector index, as it is considered the state-of-the-art in both industry and academia. However, the approach for collecting statistics can also be applied to other graph-based vector indexes such as CAGRA, Vamana, and others.

### Cost Factors

When it comes to a graph-based vector index such as HNSW, the access computational cost mainly depends on the following factors:

Number of vector distance computations: It is the number the distance computations performed while searching to find the closest k vectors to an input query vector. In practice, the distance between two vectors can reveal how similar two vectors are. Distance computations usually dominate the query search runtime. There are various distance metrics that can be used to search for similar vectors (e.g., Euclidean, cosine, hamming and more) depending on the data. For the vector index statistics and to compare different execution plans, the number of distance computations is sufficient.

Number of predicate filter evaluations (in-filter strategy): This is the number of filter evaluations that will be performed in case of the in-filter strategy (described above). The estimated number of filter evaluations allow for estimating the cost of the different filter execution strategies (e.g., pre-filter vs. in-filter).

Graph traversal cost: The cost of navigating the graph as the search algorithm examines more vectors until the closest k vectors are found.

In practice, distance computations and filter evaluations dominate the query search runtime. Thus, the graph traversal cost is not included in the statistics since it is not a decisive factor when comparing different execution plans.

### Sampling Approach

Approaches that use hard-coded heuristics can lead to sub-optimal performance while approaches that formulate the number of distance computations using some constant upper bound can result in high over-estimation of the expected number of distance computations. Contrary to those approaches, this solution of the illustrative embodiments introduces a lightweight sampling approach for collecting statistics for a given HNSW index.

The core idea is that navigating the graph using different query parameters (e.g., efSearch, filter ratio, top-k results) can provide indicative estimations about the cost of answering a query that uses similar parameters. The estimated numbers of distance computations and filter evaluations are computed on the same index that will be used for answering queries without requiring significant overhead to collect them.

### Statistics Collection

The statistics collection can be performed at any time during the life cycle of the HNSW index. For example, statistics can be collected after the index construction, as part of an automatic statistics collection framework that periodically refreshes statistics if required, on demand by the user, or if significant changes within the index have been detected (e.g., DML operations might insert new vectors, delete existing vectors, or update existing vectors of the index).

### Sample Vectors

The sampling vector is important for the quality of the statistics; therefore, it is beneficial to use sampling vectors that are similar to what the user will use in an actual query or similar to the vectors within the index. If representative query vectors are available, they can be used during the sampling phase to compute targeted statistics according to the expected queries. Otherwise, the sample vectors can be derived from the vectors within the index or by generating representative vectors from the vectors within the index (e.g., by subtracting two existing vectors), adding Gaussian noise to existing vectors, or by using synthetic query generation techniques. The sample vectors can reside either in the main memory vector storage or in disk tables.

### Sampling Size

The sampling size can be fixed, based on the dataset size, configurable by considering some user input, or dynamically adjustable based on a “budget” for collecting statistics (e.g., sampling should not take more than 5 minutes or 1% of the whole index construction). The sample size can affect the quality of the final statistics. A very small sample size can result in non-representative statistics, and a very large sample size may not improve the quality of the collected statistics while consuming significant computational resources. Increasing the sample size enables navigation through a larger portion of the graph, and therefore, the statistics will provide a more representative view of the vector index graph.

### Sampling Parameters

In case of HNSW, there are two sampling parameters, namely efSearch and filter ratio (selectivity ratio), which can be adjusted as input values. The efSearch parameter in the HNSW search algorithm controls the size of the dynamic list for the nearest neighbors (used during the search). Higher efSearch values lead to more accurate results, but slower search times, and lower values might lead to less precise results, but faster search times.

Other parameters include m and efConstruction. The m parameter is the number of bi-directional links created for every new element during construction. Increasing this parameter value may improve recall and reduce retrieval times for datasets with high intrinsic dimensionality at the expense of increased memory consumption and longer indexing time. The efConstruction parameter is the size of the dynamic list containing the nearest neighbors, which is used during index time. Increasing this parameter may improve index quality, at the expense of increased indexing time. At a certain point, increasing this parameter leads to diminishing returns.

The filter ratio represents the relationship between the “number of vectors selected according to a filter” and the “total number of vectors in the index.” In practice, as the filter ratio becomes lower, the search becomes slower, as only vectors that qualify under the filter can be potentially added as candidates for the final top results. Consequently, a larger number of vectors must be considered to identify a sufficient number of top candidates. The number of distance computations and filter evaluations depends on the efSearch value and filter ratio. Increasing the efSearch value will usually result in additional distance computations and filter evaluations. Similarly, increasing the filter ratio typically results in additional distance computations and filter evaluations during the approximate search.

The sample values of the efSearch parameter can either be predefined or configured by a user parameter. An example instance of efSearch values can be 20, 40, 80, 160, 240, 320, 480. An example instance for filter ratio can be 1.0, 0.9, 0.7, 0.5, 0.3, 0.2, 0.1, 0.05. In practice, each vector in the sample vector set will be evaluated using the efSearch and filter ratio parameters. To give an example for efSearch value 20, eight approximate searches will be performed to collect statistics, one for each value in the list of filter ratio values. In total, assuming the previous example instance values for efSearch and filter ratio, there would be performed 7*8=56 approximate searches for each sample vector.

Overall, to achieve representative statistics using the sampling approach of the illustrative embodiments does not require using extensive sampling values. A few targeted efSearch and filter ratio values can be sufficient to get a representative view of the vector index graph and to estimate the access cost during an approximate search. There is no need to collect statistics for all the possible efSearch values within some range (e.g., 10 to 500) or to consider many possible filter ratio values (e.g., [0.0,1.0]). The reason for that is that, for example, efSearch values 20 and 21 will probably result in very similar estimations about the expected number of distance computations and filter evaluations. Therefore, considering both values will not improve how representative the collected statistics are. Generally speaking, denser filter ratio sampling will not significantly improve the collected statistics; nevertheless, increasing the filter ratio sampling rate might be beneficial around the “crossover point” area. Having previous knowledge of user queries can help an expert user to tune the sampling efSearch and filter ratio values to target a specific application.

### Statistics for Approximate Filter Search

To estimate the number of distance computations and filter evaluations under different filter ratios, the solution of one embodiment emulates the approximate filter search behavior. FIG. 5 illustrates the use of a filter bitmap to emulate the approximate filter search behavior in accordance with an embodiment. To accomplish this, the solution of this embodiment generates a filter bitmap 502 for filtering for each sampling filter ratio value. During an approximate search for collecting statistics for a sample vector 504, this bitmap 502 is used similarly as a pre-filtering strategy (described above). The bitmap 504 is provided as an input and is used during graph traversal 510 to identify the corresponding top-k vectors 520. The bitmap 502 can be either randomly generated to match a specific filter ratio value or, if there is prior knowledge of user query predicates, generated using those predicates to match particular user query constraints.

### Aggregate Collected Statistics

The number of distance computations and the number of filter evaluations collected per vector in the sampling set are aggregated to summarize the vector index graph behavior for the given sampling parameters. For aggregation, the maximum, the average, or a weighted average can be used, depending on whether the cost model that exploits those statistics expects upper bounds or average values.

### Statistics Storage

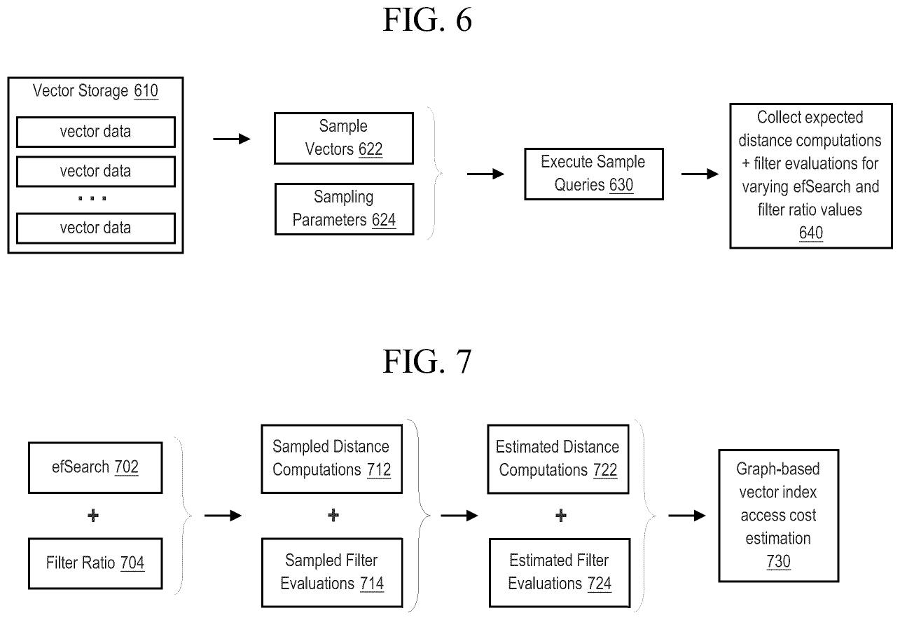

The aggregated collected statistics have a small data footprint. They depend on the number of efSearch and filter ratio values, as discussed above. There is no need for extensive sampling values. The aggregated statistics can be stored either in main memory or in a disk structure (e.g., dictionary tables). FIG. 6 is a block diagram illustrating the storage of collected statistics in accordance with an embodiment. The statistics collection sampling approach consists of the following phases:
Adjust vector sampling size and select sample vectors 622 from some main memory vector storage 610 or on disk tables.
Choose index sampling efSearch and filter ratio parameters (either pre-configured or using user input) 624.
Execute multiple approximate search queries 630 using the chosen sampling parameters.
Collect expected distance computations and filter evaluations 640 for varying efSearch and filter ratio values.

### Exploiting Collected Statistics

As previously mentioned, the main cost factors when accessing a graph-based vector index, such as HNSW, are a) the number of distance computations and b) the number of filter evaluations (needed only for in-filtering plan strategies). A system (e.g., RDBMS, vector processing library, vector database system) that uses cost-based decisions for query processing can exploit those statistics to estimate the access cost for different query plans (e.g., to evaluate pre-filtering vs. in-filtering decisions). FIG. 7 is a block diagram illustrating graph-based vector index access cost estimation in accordance with an embodiment. Given an efSearch value 702 and an estimation about the filter ratio of the input query 704, the estimated distance computations and the filter evaluations are calculated. Those estimations can then be mapped to the costing framework that makes the cost-based decisions.

The input efSearch value 702 is either provided by the user or can be estimated according to a target accuracy for the input similarity search query. The input filter ratio 704 is estimated using table-level statistics (e.g., number of rows in the table) and column-level statistics (e.g., number of distinct values and number of nulls in a column) available to the query optimizer.

The relevant number of sampled distance computations 712 and the sampled filter evaluations 714 are retrieved from the storage (e.g., memory or dictionary tables). Relevant computations or evaluations are the sampled values that are “closer” to the input efSearch and filter ratio values. For example, consider sampled efSearch values={20, 40, 80, 160, 240, 320, 480} and sampled filter ratio values={1.0, 0.9, 0.7, 0.5, 0.3, 0.2, 0.1, 0.0}. For an input efSearch value of 64 and a filter ratio value of 0.6, only the sampled values for efSearch 40 and 80 with filter ratio 0.7 and 0.5 will be retrieved (in total, four sampled values).

Then, the sampled distance computations 712 and filter evaluations 714 are adjusted to better reflect the input efSearch and filter ratio. This can be done by applying linear interpolation to generate the estimated data points based on the sampled data points for distance computations 712 and filter evaluations 714. The approach is not restricted to linear interpolation; other techniques for computing approximate solutions can be applied (e.g., polynomial interpolation, linear regression, and others). The estimated number of distance computations 722 and the estimated number of filter evaluations 724 can be included in a cost formula to estimate the graph-based vector index access cost 730.

### Procedural Overview

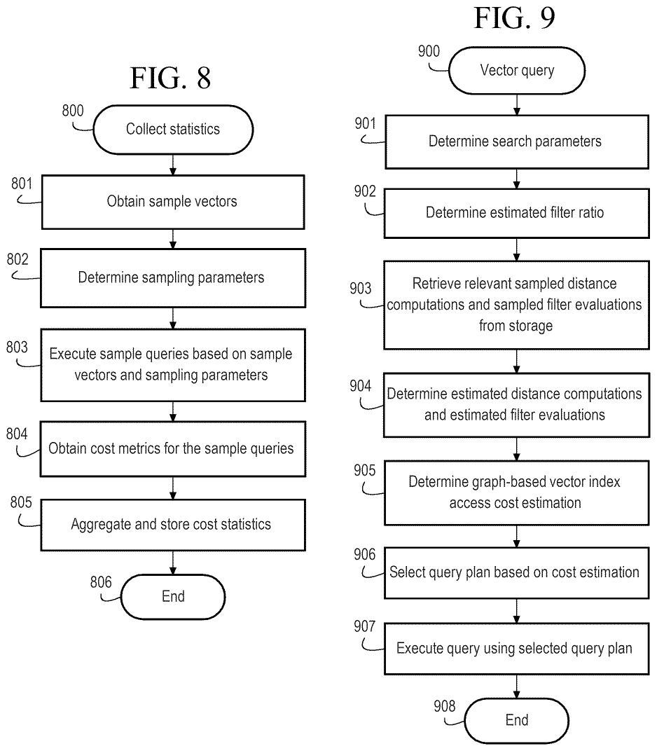

FIG. 8 is a flowchart illustrating the collection of statistics for a graph-based vector index in accordance with an embodiment. Operation begins (block 800), and a system in an RDBMS obtains sample vectors (block 801). As stated above, the sample vectors may be based on knowledge of queries that have been made by users in the past or queries that are to be made by users in the future. Alternatively, the sample vectors may be based on the vectors in the graph-based vector index (e.g., the vectors in the lowest level of the graph-based vector index).

The system determines sampling parameters (block 802). In the context of an HNSW index, the sampling parameters may include a set of efSearch values. The sampling parameters may also include a set of filter ratio values. The system executes the sample queries based on the sample vectors and a set of sampling parameters (block 803). The system obtains cost metrics for the sample queries (block 804). In some embodiments, the cost metrics include a number of a number of distance computations and a number of filter evaluations.

The system aggregates and stores the cost statistics (block 805). In one embodiment, the system stores the aggregated cost statistics in main memory. Alternatively, the system can store the aggregated cost statistics in persistent storage in association with the database. For example, the system can store the aggregated cost statistics in dictionary tables. Thereafter, the operation ends (block 806).

FIG. 9 is a flowchart illustrating the use of collected statistics for cost estimation for a graph-based vector index in accordance with an embodiment. Operation begins with a vector query (block 900), and the RDBMS determines search parameters (block 901). In some embodiments, the search parameters include an efSearch value. The RDBMS determines an estimated filter ratio (block 902). In some embodiments, the input filter ratio is calculated using table-level statistics and column-level statistics available to the query optimizer of the RDBMS.

The RDBMS retrieves relevant sampled distance computations and sampled filter evaluations from storage (block 903). The relevant sampled distance computations and sampled filter computations are the sampled values in storage that are “closer” to the input efSearch and filter ratio values. The RDBMS determines an estimated number of distance computations and an estimated number of filter evaluations based on the relevant sampled distance computations and sampled filter evaluations (block 904). In some embodiments, this can be done by applying linear interpolation to generate the estimated data points based on the sampled data points for distance computations and filter evaluations.

The RDBMS determines a graph-based vector index access cost estimation based on the estimated number of distance computations and the estimated number of filter evaluations (block 905). The RDBMS selects a query plan based on the cost estimation (block 906). The query plan can be selected from a plurality of query execution plans that use various access paths. For example, the optimizer of the RDBMS may decide between a query execution plan that uses a graph-based vector index for performing an approximate similarity search and a query execution plan for an exact similarity search without an index. As another example, the optimizer of the RDBMS may decide between an execution plan that uses a graph-based vector index with a pre-filter strategy and an execution plan that uses a graph-based vector index with an in-filter strategy. In other examples, the candidate execution plans may be based on different search parameters or different vector indexes. For instance, the optimizer of the RDBMS may decide between an execution plan that uses an NSW graph-based vector index and an execution plan that uses an HNSW graph-based vector index. The RDBMS executes the vector query using the query plan chosen (block 907). Thereafter, the operation ends (block 908).

### DBMS Overview

A database management system (DBMS) manages a database. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, a branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .java file) and the compiled version of the class (i.e. .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data type and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

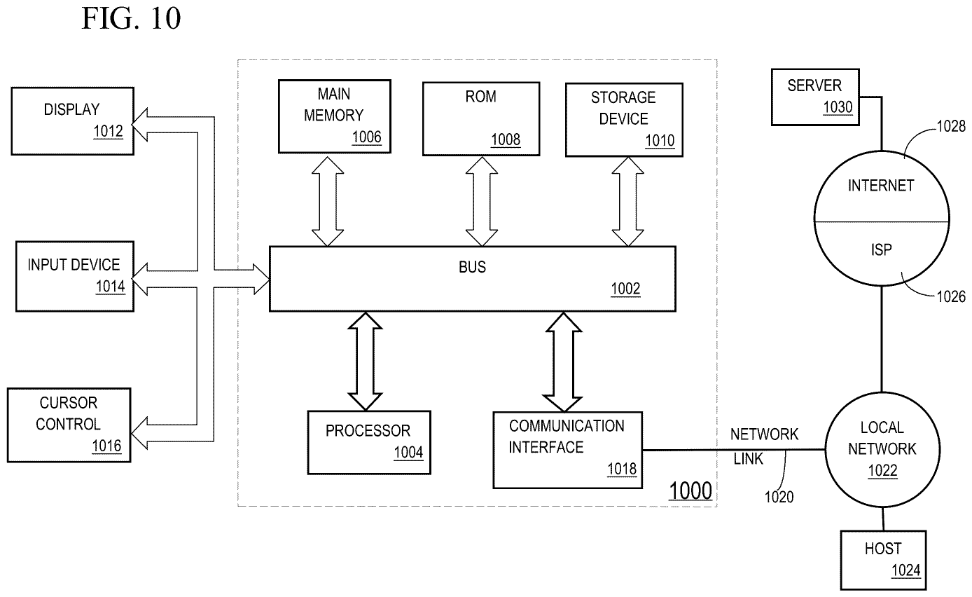

For example, FIG. 10 is a block diagram that illustrates a computer system 1000 upon which aspects of the illustrative embodiments may be implemented. Computer system 1000 includes a bus 1002 or other communication mechanism for communicating information, and a hardware processor 1004 coupled with bus 1002 for processing information. Hardware processor 804 may be, for example, a general-purpose microprocessor.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world-wide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### Software Overview

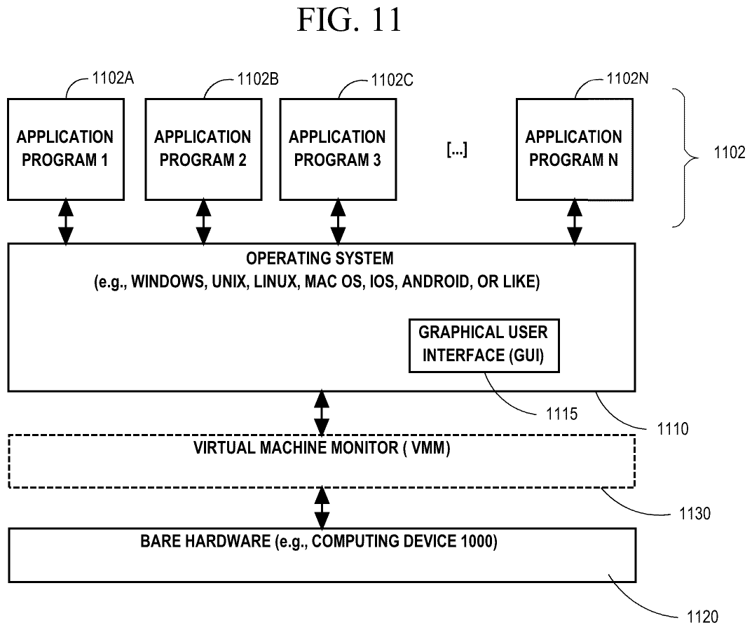

FIG. 11 is a block diagram of a basic software system 1100 that may be employed for controlling the operation of computer system 1000 upon which aspects of the illustrative embodiments may be implemented. Software system 1100 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1100 is provided for directing the operation of computer system 1000. Software system 1100, which may be stored in system memory (RAM) 1006 and on fixed storage (e.g., hard disk or flash memory) 1010, includes a kernel or operating system (OS) 1110.

The OS 1110 manages low-level aspects of computer operation, including managing execution of processes, memory allocation, file input and output (I/O), and device I/O. One or more application programs, represented as 1102A, 1102B, 1102C . . . 1102N, may be “loaded” (e.g., transferred from fixed storage 1010 into memory 1006) for execution by system 1100. The applications or other software intended for use on computer system 1000 may also be stored as a set of downloadable computer-executable instructions, for example, for downloading and installation from an Internet location (e.g., a Web server, an app store, or other online service).

Software system 1100 includes a graphical user interface (GUI) 1115, for receiving user commands and data in a graphical (e.g., “point-and-click” or “touch gesture”) fashion. These inputs, in turn, may be acted upon by system 1100 in accordance with instructions from operating system 1110 and/or application(s) 1102. The GUI 1115 also serves to display the results of operation from the OS 1110 and application(s) 1102, whereupon the user may supply additional inputs or terminate the session (e.g., log off).

OS 1110 can execute directly on the bare hardware 1120 (e.g., processor(s) 1004) of computer system 1000. Alternatively, a hypervisor or virtual machine monitor (VMM) 1130 may be interposed between the bare hardware 1120 and the OS 1110. In this configuration, VMM 1130 acts as a software “cushion” or virtualization layer between the OS 1110 and the bare hardware 1120 of the computer system 1000.

VMM 1130 instantiates and runs one or more virtual machine instances (“guest machines”). Each guest machine comprises a “guest” operating system, such as OS 1110, and one or more applications, such as application(s) 1102, designed to execute on the guest operating system. The VMM 1130 presents the guest operating systems with a virtual operating platform and manages the execution of the guest operating systems.

In some instances, the VMM 1130 may allow a guest operating system to run as if it is running on the bare hardware 1120 of computer system 1100 directly. In these instances, the same version of the guest operating system configured to execute on the bare hardware 1120 directly may also execute on VMM 1130 without modification or reconfiguration. In other words, VMM 1130 may provide full hardware and CPU virtualization to a guest operating system in some instances.

In other instances, a guest operating system may be specially designed or configured to execute on VMM 1130 for efficiency. In these instances, the guest operating system is “aware” that it executes on a virtual machine monitor. In other words, VMM 1130 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
collecting statistics for an in-memory graph-based vector index, wherein collecting the statistics comprises:
executing a plurality of sample queries based on a set of search parameter values, a set of sampling filter ratios, and a set of sample vectors to perform a similarity search of a vector store using the in-memory graph-based vector index;
determining, for each sample query within the plurality of sample queries, at least one cost statistic based on the execution; and
storing the cost statistics for the plurality of sample queries;
executing, by a database system, a vector query with a filter condition to search the vector store, wherein executing the vector query comprises:
determining a cost estimation for graph-based index access based at least in part on the set of cost statistics; and
executing the vector query based at least in part on the cost estimation for graph-based index access,
wherein the method is performed by one or more computing devices.

2. The method of claim 1, wherein determining the cost estimation further comprises:
determining one or more search parameter values for the vector query;
determining an estimated filter ratio based on the filter condition; and
determining the cost estimation for graph-based index access based at least in part on the one or more search parameter values, the estimated filter ratio, and the set of cost statistics.

3. The method of claim 2, wherein determining the estimated filter ratio comprises determining the estimated filter ratio based on at least one of table statistics or column statistics of one or more database tables of the vector store.

4. The method of claim 2, wherein determining the cost estimation for graph-based index access comprises performing interpolation of the cost statistics based on at least one of the one or more search parameter values or the estimated filter ratio.

5. The method of claim 1, wherein:
executing the vector query comprises selecting a query plan from a set of candidate query plans,
the set of candidate query plans includes a first subset of candidate query plans and a second subset of candidate query plans,
the first subset of candidate query plans comprises a set of index-based query plans, and
the second subset of candidate query plans comprises a set of search query plans.

6. The method of claim 5, wherein:
execution of each sample query within the plurality of sample queries uses a filtering strategy selected from a group including pre-filter, in-filter, and post filter, and
each index-based query plan within the first subset of candidate query plans uses a filtering strategy selected from the group including pre-filter, in-filter, and post-filter.

7. The method of claim 1, wherein:
the at least one cost statistic determined for each sample query comprises a number of vector distance computations and a number of predicate filter evaluations, and
determining the cost estimation for each index-based query plan comprises determining the cost estimation based at least in part on the number of vector distance computations and the number of predicate filter evaluations.

8. The method of claim 1, wherein executing the plurality of sample queries comprises:
generating a bitmap for each sampling filter ratio value in the set of sampling filter ratios; and
applying the bitmap to vectors in the in-memory graph-based vector index during the similarity search.

9. The method of claim 1, wherein collecting the statistics comprises aggregating the cost statistics collected for each sample vector in the set of sampling vectors to summarize behavior of the in-memory graph-based vector index for the set of search parameter values.

10. The method of claim 9, wherein aggregating the cost statistics comprises aggregating based on a maximum, average, or weighted average.

11. The method of claim 1, wherein the set of search parameter values comprises values corresponding to a size of a dynamic list for nearest neighbors.

12. The method of claim 1, wherein the in-memory graph-based vector index comprises a hierarchical navigable small-world (HNSW) index.

13. One or more non-transitory computer-readable media storing instructions which, when executed by one or more processors, cause:
collecting statistics for an in-memory graph-based vector index, wherein collecting the statistics comprises:
executing a plurality of sample queries based on a set of search parameter values, a set of sampling filter ratios, and a set of sample vectors to perform a similarity search of a vector store using the in-memory graph-based vector index;
determining, for each sample query within the plurality of sample queries, at least one cost statistic based on the execution; and
storing the cost statistics for the plurality of sample queries;
executing, by a database system, a vector query with a filter condition to search the vector store, wherein executing the vector query comprises:
determining a cost estimation for graph-based index access based at least in part on the set of cost statistics; and
executing the vector query based at least in part on the cost estimation for graph-based index access.

14. The one or more non-transitory computer-readable media of claim 13, wherein determining the cost estimation further comprises:
determining one or more search parameter values for the vector query;
determining an estimated filter ratio based on the filter condition; and
determining the cost estimation for graph-based index access based at least in part on the one or more search parameter values, the estimated filter ratio, and the set of cost statistics.

15. The one or more non-transitory computer-readable media of claim 14, wherein determining the estimated filter ratio comprises determining the estimated filter ratio based on at least one of table statistics or column statistics of one or more database tables of the vector store.

16. The one or more non-transitory computer-readable media of claim 14, wherein determining the cost estimation for graph-based index access comprises performing interpolation of the cost statistics based on at least one of the one or more search parameter values or the estimated filter ratio.

17. The one or more non-transitory computer-readable media of claim 13, wherein:
executing the vector query comprises selecting a query plan from a set of candidate query plans,
the set of candidate query plans includes a first subset of candidate query plans and a second subset of candidate query plans,
the first subset of candidate query plans comprises a set of index-based query plans, and
the second subset of candidate query plans comprises a set of exact search query plans.

18. The one or more non-transitory computer-readable media of claim 17, wherein:
execution of each sample query within the plurality of sample queries uses a filtering strategy selected from a group including pre-filter, in-filter, and post filter, and
each index-based query plan within the first subset of candidate query plans uses a filtering strategy selected from the group including pre-filter, in-filter, and post-filter.

19. The one or more non-transitory computer-readable media of claim 13, wherein:
the at least one cost statistic determined for each sample query comprises a number of vector distance computations and a number of predicate filter evaluations, and
determining the cost estimation for each index-based query plan comprises determining the cost estimation based at least in part on the number of vector distance computations and the number of predicate filter evaluations.

20. The one or more non-transitory computer-readable media of claim 13, wherein executing the plurality of sample queries comprises:
generating a bitmap for each sampling filter ratio value in the set of sampling filter ratios; and
applying the bitmap to vectors in the in-memory graph-based vector index during the similarity search.
